(19) United States
(12) Patent Application Publication
(10) Pub. No.: US 2014/0278395 A1
(43) Pub. Date: Sep. 18, 2014

(54) Method and Apparatus for Determining a Motion Environment Profile to Adapt Voice Recognition Processing

(71) Applicant: Motorola Mobility LLC, Libertyville, IL (US)

(72) Inventors: Robert A. Zurek, Antioch, IL (US); Kevin J. Bastyr, Milwaukee, WI (US); Giles T. Davis, Mundelein, IL (US); Plamen A. Ivanov, Schaumburg, IL (US); Adrian M. Schuster, West Olive, MI (US)

(73) Assignee: Motorola Mobility LLC, Libertyville, IL (US)

(21) Appl. No.: 13/956,131

(22) Filed: Jul. 31, 2013

Related U.S. Application Data
(60) Provisional application No. 61/776,793, filed on Mar. 12, 2013.
(60) Provisional application No. 61/798,097, filed on Mar. 15, 2013.
(60) Provisional application No. 61/827,723, filed on May 27, 2013.

(51) Int. Cl. G10L 15/065

(52) U.S. Cl. CPC G10L 15/065
USPC 704/233; 704/231; 704/243

(57) ABSTRACT

A method and apparatus for determining a motion environment profile to adapt voice recognition processing includes a device receiving an acoustic signal including a speech signal, which is provided to a voice recognition module. The method also includes determining a motion profile for the device, determining a temperature profile for the device, and determining a noise profile for the acoustic signal. The method further includes determining, from the motion, temperature, and noise profiles, a motion environment profile for the device and adapting voice recognition processing for the speech signal based on the motion environment profile.

### FIELD OF THE DISCLOSURE

The present disclosure relates generally to voice recognition and more particularly to determining a motion environment profile to adapt voice recognition.

### BACKGROUND

Mobile electronic devices, such as smartphones and tablet computers, continue to evolve through increasing levels of performance and functionality as manufacturers design products that offer consumers greater convenience and productivity. One area where performance gains have been realized is in voice recognition. Voice recognition frees a user from the restriction of a device's manual interface while also allowing multiple users to access the device more efficiently. Currently, however, new innovation is required to support a next-generation of voice-recognition devices that are better able to overcome difficulties associated with noisy or otherwise complex environments.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a device in accordance with some embodiments of the present teachings.

FIG. 2 is a block diagram of a device configured for implementing embodiments in accordance with the present teachings.

FIG. 3 is a logical flowchart of a method for determining a motion environment profile and adapting voice recognition processing in accordance with some embodiments of the present teachings.

FIG. 4 is a schematic diagram illustrating determining a motion environment profile and adapting voice recognition processing in accordance with some embodiments of the present teachings.

FIG. 5 is a table of transportation modes associated with average speeds in accordance with some embodiments of the present teachings.

FIG. 6 is a diagram showing velocity components for a jogger in accordance with some embodiments of the present teachings.

FIG. 7 is a diagram showing velocity components and a percussive interval for a runner in accordance with some embodiments of the present teachings.

FIGS. 8A and 8B are diagrams showing relative motion between a device and a runner's mouth for two runners in accordance with some embodiments of the present teachings.

FIG. 9 is a schematic diagram illustrating determining a temperature profile for a device in accordance with some embodiments of the present teachings.

FIG. 10 is a schematic diagram illustrating determining a motion profile for a device in accordance with some embodiments of the present teachings.

FIG. 11 is a logical flowchart of a method for determining the stationarity of noise to perform noise reduction in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for determining a motion environment profile to adapt voice recognition processing. Using a characterization of a motion environment for a device, the device improves a speech signal, reduces noise, and implements voice-recognition module changes to increase speech-recognition accuracy. In accordance with the teachings herein a method performed by a device for adapting voice recognition processing includes receiving into the device an acoustic signal including a speech signal, which is provided to a voice recognition module. The method also includes determining a motion profile for the device, determining a temperature profile for the device, and determining a noise profile for the acoustic signal. The method further includes determining, from the motion, temperature, and noise profiles, a motion environment profile for the device and adapting voice recognition processing for the speech signal based on the motion environment profile.

Also in accordance with the teachings herein is a device configured to perform voice recognition that includes at least one acoustic transducer configured to receive an acoustic signal including a speech signal and a voice-recognition module configured to perform voice recognition on the speech signal. The device additionally includes a set of motion sensors configured to collect motion data, a temperature sensor configured to measure a first temperature at the device, and an interface configured to receive a second temperature for the location of the device. Further, the device includes a processing element configured to determine, from the acoustic signal, the motion data, and the first and second temperatures, a motion environment profile for the device and to adapt voice recognition processing for the speech signal based on the motion environment profile.

Referring now to the drawings, and in particular FIG. 1, an electronic device (also referred to herein simply as a “device”) implementing embodiments in accordance with the present teachings is shown and indicated generally at 102. Specifically, device 102 represents a smartphone including: a user interface 104, capable of accepting tactile input and displaying visual output; a thermocouple 106, capable of taking a local temperature measurement; and right- and left-side microphones, at 108 and 110, respectively, capable of receiving audio signals at each of two locations.

While a smartphone is shown at 102, no such restriction is intended or implied as to the type of device to which these teachings may be applied. Other suitable devices include, but are not limited to: personal digital assistants (PDAs); audio- and video-file players (e.g., MP3 players and iPODs); personal computing devices, such as tablets; and wearable electronic devices, such as devices worn with a wristband. For purposes of these teachings, a device can be any apparatus that has access to a voice-recognition engine, is capable of determining a motion environment profile, and can receive an acoustic signal.

Referring to FIG. 2, a block diagram for a device in accordance with embodiments of the present teachings is shown and indicated generally at 200. For one embodiment, the block diagram 200 represents the device 102. Specifically, the schematic diagram 200 shows: an audio input module 202, motion sensors 204, a voice recognition module 206, a voice activity detector (VAD) 208, non-volatile storage 210, memory 212, a processing element 214, a signal processing module 216, a cellular transceiver 218, and a wireless-local-area-network (WLAN) transceiver 220, all operationally interconnected by a bus 222.

A limited number of device elements 202-222 are shown at 200 for ease of illustration, but other embodiments may include a lesser or greater number of such elements in a device, such as device 102. Moreover, other elements needed for a commercial embodiment of a device that incorporates the elements shown at 200 are omitted from FIG. 2 for clarity in describing the enclosed embodiments.

We now turn to a brief description of the elements within the schematic diagram 200. In general, the audio input module 202, the motion sensors 204, the voice recognition module 206, the processing element 214, and the signal processing module 216 are configured with functionality in accordance with embodiments of the present disclosure as described in detail below with respect to the remaining figures. “Adapted,” “operative,” “capable” or “configured,” as used herein, means that the indicated elements are implemented using one or more hardware devices such as one or more operatively coupled processing cores, memory devices, and interfaces, which may or may not be programmed with software and/or firmware as the means for the indicated elements to implement their desired functionality. Such functionality is supported by the other hardware shown in FIG. 2, including the device elements 208, 210, 212, 218, 220, and 222.

Continuing with the brief description of the device elements shown at 200, as included within the device 102, the processing element 214 includes arithmetic logic and registers necessary to perform the digital processing required by the device 102 to process image data and aid voice recognition in a manner consistent with the embodiments described herein. For one embodiment, the processing element 214 represents a primary microprocessor of the device 102. For example, the processing element 214 can represent an application processor of the smartphone 102. In another embodiment, the processing element 214 is an ancillary processor, separate from a central processing unit (CPU), dedicated to providing the processing capability, in whole or in part, needed for the device elements 200 to perform their intended functionality.

The audio input module 202 includes elements needed to receive acoustic signals that include speech, represented by the voice of a single or multiple individuals, and to convert the speech into voice data that can be processed by the voice recognition module 206 and/or the processing element 214. For a particular embodiment, the audio input module 202 includes one or more acoustic transducers, which for device 102 are represented by the microphones 108 and 110. The acoustic transducers covert the acoustic signals they receive into electronic signals, which are encoded for storage and processing using codecs such as the recursively named codec LAME Ain't an MP3 Encoder (LAME).

The block element 204 represents one or more motion sensors that allow the device 102 to determine its motion relative to its environment and/or motion of the environment relative to the device 102. For example, the motion sensors 204 can measure the speed of a device 102 through still air or measure the wind speed relative to a stationary device with no ground speed. The motion sensors 204 can include, but are not limited to: accelerometers, velocity sensors, air flow sensors, gyroscopes, and global positioning system (GPS) receivers. Multiple sensors of a common type can also take measurements along different axial directions. For some embodiments, the motion sensors 204 include hardware and software elements that allow the device 102 to triangulate its position using a communications network. In further embodiments, the motion sensors 204 allow the device 102 to determine its position, velocity, acceleration, additional derivatives of position with respect to time, average quantities associated with the aforementioned values, and the route it travels. For a particular embodiment, the device 102 has a set of motion sensors 204 that includes at least one of: an accelerometer, a velocity sensor, and air flow sensor, a GPS receiver, or network triangulation hardware. As used herein, a set is defined to consist of one or more elements.

The voice recognition module 206 includes hardware and/or software elements needed to process voice data by recognizing words. As used herein, voice recognition refers to the ability of hardware and/or software elements to interpret speech. In one embodiment, processing voice data includes converting speech to text. This type of processing is used, for example, when one is dictating an e-mail. In another embodiment, processing voice data includes identifying commands from speech. This type of processing is used, for example, when one wishes to give a verbal instruction or command, for instance to the device 102. For different embodiments, the voice recognition module 206 can include a single or multiple voice recognition engines of varying types that are best suited for a particular task or set of conditions. For instance, certain types of voice recognition engines might work best for speech-to-text conversion, and of those voice recognition engines, different ones might be optimal depending on the specific characteristics of a voice and/or conditions relating to the environment of the device 102.

The VAD 208 represents hardware and/or software that enables the device 102 to discriminate between those portions of a received acoustic signal that include speech and those portions that do not. In voice recognition, the VAD 208 is used to facilitate speech processing, obtain isolated noise samples, and to suppress non-speech portions of acoustic signals.

The non-volatile storage 210 provides the device 102 with long-term storage for applications, data tables, and other media used by the device 102 in performing the methods described herein. For particular embodiments, the device 102 uses magnetic (e.g., hard drive) and/or solid state (e.g., flash memory) storage devices. The memory 212 represents short-term storage, which is purged when a power supply for the device 102 is switched off and the device 102 powers down. In one embodiment, the memory 212 represents random access memory (RAM) having faster read and write times than the non-volatile storage 210.

The signal processing module 216 includes the hardware and/or software elements used to process an acoustic signal that includes a speech signal, which represents the voice portion of the acoustic signal. The signal processing module 216 processes an acoustic signal by improving the voice portion and reducing noise. This is done using filtering and other electronic methods of signal transformation that can affect the levels and types of noise in the acoustic signal and affect the rate of speech, pitch, and frequency of the speech signal. In one embodiment, the signal processing module 216 is configured to adapt voice recognition processing by modifying at least one of a frequency of speech, an amplitude of speech, or a rate of speech for the speech signal. For a particular embodiment, the processing of the signal processing module 216 is performed by the processing element 214.

The cellular transceiver 218 allows the device 102 to upload and download data to and from a cellular network. The cellular network can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) or pre-4G wireless networks such as LTE and WiMAX. Additionally, the WLAN transceiver 220 allows the device 102 direct access to the Internet using standards such as Wi-Fi.

A power supply (not shown) supplies electric power to the device elements, as needed, during the course of their normal operation. The power is supplied to meet the individual voltage and load requirements of the device elements that draw electric current. The power supply also powers up and powers down a device. For a particular embodiment, the power supply includes a rechargeable battery.

We turn now to a detailed description of the functionality of the device 102 and device elements shown in FIGS. 1 and 2 at 102 and 200, respectively, in accordance with the teachings herein and by reference to the remaining figures. FIG. 3 is a logical flow diagram illustrating a method 300 performed by a device, taken to be device 102 for purposes of this description, for adapting voice recognition processing in accordance with some embodiments of the present teachings. Specifically, the device 102 receives 302 an acoustic signal that includes a speech signal. The speech signal is the voice or speech portion of the acoustic signal, that portion for which voice recognition is performed. Data acquisition that drives the method 300 is three-fold and includes the device 102 determining a motion profile, a temperature profile, and a noise profile at 304, 306, and 308 respectively. The device 102 collects and analyzes data in connection with determining these three profiles to determine if conditions related to the status of the device 102 will expose the device 102 to velocity-created noise or modulation effects that will hamper voice recognition.

The motion profile for the device 102 is a representation of the status of the device 102 and its environment as determined by data collected using the motion sensors 204. In some embodiments, the device 102 also receives motion data from remote sources using its cellular 218 or WLAN 220 transceiver. For an embodiment, information included in the motion profile includes, but is not limited to: a velocity of the device 102, an average speed of the device 102, a wind speed at the device 102, a transportation mode of the device 102, and an indoor or outdoor indication for the device 102.

The transportation mode of the device 102, as used herein, identifies the method by which the device 102 is moving. Motor vehicle and airplane travel are examples of a transportation mode. Under some circumstances, the transportation mode can also represent a physical activity (e.g., exercise) engaged in by a user carrying the device 102. For example, walking, running, and bicycling are transportation modes that indicate a type of activity.

An indication of the device 102 being indoors or outdoors is an indication of whether the device 102 is in a climate-controlled environment or is exposed to the elements. A determination of whether the device 102 is indoors or outdoors as it receives the acoustic signal is a factor that is weighed by the device 102 in determining the type of noise reduction to implement. Wind noise, for instance, is an outdoor phenomenon. Indoor velocities are usually insufficient to generate a wind-related noise that results from the device 102 moving through stationary air.

An indoor or outdoor indication can also help identify a transportation mode for the device 102. Bicycling, for example, is an activity that is usually conducted outdoors. An indoor indication for the device 102 while it is traveling at a speed typically associated with biking would tend to suggest a user of the device 102 is traveling in a slow-moving automobile rather than riding a bike. An automobile can also represent an outdoor environment, as is the case when the windows are rolled down, for example. Other transportation modes, such as trains and airplanes, do not have windows that open and therefore consistently identify as indoor environments.

The temperature profile for the device 102 is a representation of the status of the device 102 and its environment as determined by temperature data that is both collected (e.g., measured) locally and obtained from a remote source. For an embodiment, information included in the temperature profile includes a temperature indication. The temperature indication is an indication of whether the device 102 is indoors or outdoors as determined by a temperature difference between a temperature measured at the device 102 and a temperature reported for the location of the device 102. A further description of determining a temperature profile for the device 102 is provided with reference to FIG. 9.

The noise profile for the acoustic signal received by the device 102 is compiled from acoustic information collected by one or more acoustic transducers 108, 110 for the device 102 (or sampled from the acoustic signal) that is analyzed by the audio input module 202, voice activity detector 208, and/or the processing element 214. For an embodiment, information included in the noise profile includes, but is not limited to: spectral and amplitude information on ambient noise, a noise type, and the stationarity of noise in the acoustic signal.

For one embodiment, the device 102 determines the type of noise to be wind noise, road noise, and/or percussive noise. The device 102 can determine a noise type by using both spectral and temporal information. The device 102 might identify wind noise, for example, by analyzing the correlation between multiple acoustic transducers (e.g., microphones 108, 110) for the acoustic signal. An acoustic event that occurs at a specific time has correlation between multiple microphones, whereas wind noise has none. A point-source noise (originating from a single point at a single time), such as a percussive shock, for instance, is completely correlated because the sound reaches multiple microphones in order of their distance from the point source. Wind noise, by contrast, is completely uncorrelated because the noise is continuous and generated independently at each microphone. In an embodiment, the device 102 also identifies and categorizes percussive noise as footfalls, device impacts, or vehicle impacts due to road irregularities (e.g., pot holes). A further description of percussive noise is provided with reference to FIG. 7, and a further description involving the stationarity of noise is provided with reference to FIG. 11.

From the motion, temperature, and noise profiles, the device 102 determines 310 a motion environment profile. Integrating information represented by the motion, temperature, and noise profiles into a single global profile allows the motion environment profile to be a more complete and accurate profile than a simple aggregate of the profiles used to create it. This is because new suppositions and determinations are made from the combined information. For example, the motion, temperature, and noise profiles can provide separate indications of whether the device 102 is indoors or outdoors. A transportation mode might suggest an outdoor activity, while the noise profile indicates an absence of wind, and the temperature profile indicates an outdoor temperature. In an embodiment, this information is combined, possibly with additional information, to set an indoor/outdoor flag within the motion environment profile that is a more accurate representation of the indoor/outdoor status of the device 102 than can be provided by the motion, temperature, or noise profiles in isolation.

In one embodiment, settings or flags within the motion environment profile are determined from the motion, temperature, and noise profiles using look-up tables stored locally on the device 102 or accessed by it remotely. The device 102 compares values specified by the motion, temperature, and noise profiles against a predefined table of values, which returns an estimation of the motion environment profile for device 102. For example, if a transportation mode flag is set to “vehicular travel,” a wind flag is set to “inside” and a temperature flag is set to “inside,” the device 102 determines the motion environment profile to be enclosed vehicular travel. In another embodiment, the settings or flags within the motion environment profile are determined from the motion, temperature, and noise profiles using one or more programmed algorithms.

Based on the motion environment profile, the device 102 adapts 312 its voice recognition processing for the speech signal. Adapting voice recognition processing is done to aid or enhance voice recognition accuracy by mitigating adverse effects motion can have on the received acoustic signal. Motion related activities, for example, can create noise in the acoustic signal and cause modulation effects in the speech signal. A further description of motion-related modulation effects in the speech signal is provided with reference to FIGS. 8A and 8B.

FIG. 4 is a schematic diagram 400 illustrating the creation of a motion environment profile and its use in adapting voice recognition processing in accordance with some embodiments of the present teachings. Shown at 400 are schematic representations of: the motion profile 402, the temperature profile 404, the noise profile 406, the motion environment profile 408, signal improvement 410, noise reduction 412, and a voice recognition module change 414. More specifically, the diagram 400 shows the functional relationship between the illustrated elements.

For an embodiment, adapting voice recognition processing to enhance voice recognition accuracy includes the application of signal improvement 410, noise reduction 412, and a voice recognition module change 414. In alternate embodiments, adapting voice recognition processing includes the remaining six different ways to combine (excluding the empty set) signal improvement 410, noise reduction 412, and a voice recognition module change 414 (i.e., {410, 412}; {410, 414}; {412, 414}; {410}; {412}; {414}). Ina similar manner, the device 102 can draw on different combinations of the motion 402, temperature 404, and noise 406 profiles to compile its motion environment profile 408. In the specific embodiment shown at 400, the device 102 determines a motion environment profile 408 from a motion profile 402 and a temperature profile 404. The device 102 uses the motion environment profile 408, in turn, to adapt voice recognition processing by improving the speech signal (also referred to herein as modifying the speech signal) and making a change to the voice recognition module 206 (also referred to herein as adapting the voice recognition module 206).

For one embodiment, adapting voice recognition processing for the speech signal includes modifying the speech signal before providing the speech signal to a voice recognition engine within the voice recognition module 206. For a particular embodiment, the device 102 determining the noise profile 406 includes the device 102 determining at least one of noise level or noise type, and the device 102 modifying the speech signal includes the device 102 modifying at least one phoneme within the speech signal based on at least one of the noise level or the noise type. Having knowledge of the instantaneous velocities and accelerations of the device 102 as a function of time, for example, allows the device 102 to modify the speech signal to overcome the adverse effects of repetitive motion on the modulation of the speech signal, as described below with reference to FIGS. 8A and 8B.

For another embodiment, adapting voice recognition processing for the speech signal includes adapting the voice recognition module 206, which includes at least one of: selecting a voice recognition database based on the motion environment profile 408; or selecting a voice recognition engine based on the motion environment profile 408. In a first embodiment, the device 102 determines that a particular voice recognition database produces the most accurate results given the motion environment profile 408. The status and environment of the device 102, as described by the motion environment profile 408, can affect the phonetic characteristics of the speech signal. Individual phonemes, the phonetic building blocks of speech, can be altered either before or after they are spoken. In a first example, stress due to vigorous exercise (such as running) can change the way words are spoken. Speech can become labored, hurried, or even pitched (e.g., have a higher perceived tonal quality). The device 102 selects the correct voice recognition database for specifically the type of phonetic changes the current type of user activity (as indicated by the motion environment profile 408) causes. In a second example, the phonemes are altered after they are spoken, for instance, as pressure differentials, representing speech, move through the air and interact with wind.

In a second embodiment, the device 102 determines that a particular voice recognition engine produces the most accurate results given the motion environment profile 408. A first voice recognition engine might work best, for example, when the acoustic signal includes a higher-pitched voice (such as a woman's voice) in combination with a low signal-to-noise ratio due in part to wind noise. Alternatively, a second voice recognition engine might work best when the acoustic signal includes a deeper voice (such as a man's voice) and does not include wind noise. In other embodiments, different voice recognition engines might be best suited for specific accents or spoken languages. In a further embodiment, the device 102 can download a software component of a voice recognition engine using its cellular 218 or WLAN 220 transceiver.

For a particular embodiment in which the device 102 includes a first and a second voice recognition engine, the device 102 adapts voice recognition processing by selecting the second voice recognition engine, based on the motion environment profile 408, to replace the first voice recognition engine as an active voice recognition engine. The active voice recognition engine at any given time is the one the device 102 uses to perform voice recognition on the speech signal. In a further embodiment, loading or downloading a software component of a voice recognition engine represents a new selection of an active voice recognition engine where the device 102 switches from a previously used software component to the newly loaded or downloaded one.

In other embodiments, adapting the voice recognition module 206 includes changing a microphone, or a number of microphones, used to receive the acoustic signal. For a particular embodiment, a change of microphones is determined using an algorithm run by the processing element 214 or another processing core with the device 102. Further descriptions related to adapting the voice recognition module 206 are provided with reference to FIGS. 7 and 11.

In further embodiments, adapting voice recognition processing for the speech signal includes performing noise reduction. For one embodiment, the noise reduction applied to the acquired audio signal is based on an activity type (as determined by the transportation mode), the device velocity, and a measured and/or determined noise level. The types of noise reduced include wind noise, road noise, and percussive noise. To determine a type of noise reduction, the device 102 analyzes the spectrum and stationarity of a noise sample. For some embodiments, the device 102 also analyzes the amplitudes and/or coherence of the noise sample. The noise sample can be taken from the acoustic signal or a separate signal captured by one or more microphones 108, 110. The device 102 uses the VAD 208 to isolate a portion of the signal that is free of speech and suitable for use as an ambient noise sample.

For an embodiment, a determination that the noise is stationary or non-stationary determines a class of noise reduction employed by the device 102. Once a noise type is identified, based on spectral and temporal information, the device 102 applies an equalization or compensation filter specific to that type of noise. For example low frequency stationary noise, like wind noise, can be reduced with a filter or by using band suppression or band compression. For an embodiment, the amount of attenuation the filter or band suppression algorithm provides is based on sub-100 Hz energy measured from the captured signal. Alternatively when multiple microphones are used, the amount of suppression is based on the uncorrelated low-frequency energy from the two or more microphones 108, 110. A particular embodiment utilizes a suppression filter based on the transportation mode that varies suppression as a function of the velocity measured by the device 102. This noise-reduction variation, for example, shifts the filter corner based on speed of the device 102. In a further embodiment, the device determines its speed using an air-flow sensor and/or a GPS receiver.

In further embodiments, the level of suppression in each band is a function of the device 102 velocity and distinct from the level of suppression for surrounding bands. In one embodiment, noise reduction takes the form of a sub-band filter used in conjunction with a compressor to maintain the spectral characteristics of the speech signal. Alternatively, the filter adapts to noise conditions based on the information provided by sensors and/or microphones. A particular embodiment uses multiple microphones to determine the spectral content in the low-frequency region of the noise spectrum. This is useful when a transfer function (e.g., a handset-related transfer function) between the microphones is negligible. In this case, large differences for this spectral region may be attributed to wind noise or other low frequency noise, such as road noise. A filter shape for this embodiment can be derived as a function of multiple observations in time. In an alternate embodiment, the amount of suppression in each band is based on continuously sampled noise and changes as a function of time.

Another embodiment for the use of sensors to aid in the reduction of noise in the acquired acoustic signal uses the residual motion detected by an accelerometer in the device 102 to identify and suppress percussive noise incidents. Residual motions represent time-dependent velocity components that do not align with the time-averaged velocity for the device 102. In some instances, the membrane of a microphone will react to a large shock (i.e., an acceleration or time derivative of the velocity vector). The resulting noise depends on how the axis of the microphone is orientated with respect to the acceleration vector. These types of percussive events may be suppressed using an adaptive filter, or alternatively, by using a compressor or gate function triggered by an impulse, indicating the percussive incident, as detected by the accelerometer. This method aids significantly in the reduction of mechanical shock noise imparted to microphone membranes that acoustic methods of noise reduction cannot suppress.

For some embodiments of the method 300, the device 102 determining a motion profile includes the device 102 determining a time-averaged velocity for the device 102 and determining a transportation mode based on the time-averaged velocity. For a first embodiment, the device 102 uses the processing element 214 to determine the time-averaged velocity over a time interval from a time-dependent velocity measured over the time interval. As used herein, velocity is defined as a vector quantity, and speed is defined as a scalar quantity that represents the magnitude of a velocity vector. In one embodiment, the time-dependent velocity is measured using a velocity sensor at particular intervals or points in time. In another embodiment the time-dependent velocity is determined by integrating acceleration, as measured by an accelerometer of the device 102, over a time interval where the initial velocity at the beginning of the interval serves as the constant of integration.

For a second embodiment, the device 102 determines its time-averaged velocity using time-dependent positions. The device 102 does this by dividing a displacement vector by the time it took the device 102 to achieve the displacement. If the device 102 is displaced one mile to the East in ten minutes, for example, then its time-averaged velocity over those ten minutes is 6 miles per hour (mph) due East. This time-averaged velocity does not depend on the actual route the device 102 took. The time-averaged speed of the device 102 over the interval is simply 6 mph without a designation of direction. In a further embodiment, the device 102 uses a GPS receiver to determine its position coordinates at the particular times it uses to determine its average velocity. Alternatively, the device 102 can also use network triangulation to determine its position.

The average velocity represents a consistent velocity for the device 102, where time-dependent fluctuations are cancelled or averaged out over time. The average velocity of a car navigating a road passing over rolling hills, for instance, will indicate its horizontal (forward) motion but not its vertical (residual) motion. It is the average velocity of the device 102 that introduces acoustic noise to the acoustic signal and that can modulate a user's voice in a way that hampers voice recognition. Both the average velocity and the residual velocity, however, provide information that allows the device 102 to determine its transportation mode.

FIG. 5 shows a table 500 indicating five transportation modes, each associated with a different range of average speeds for the device 102, consistent with an embodiment of the present teachings. When the motion profile 402 indicates an average speed for the device 102 of less than 5 mph, the motion environment profile 408 indicates walking as the transportation mode for the device 102. Conversely, an average speed of more than 90 mph indicates the device 102 is in flight. The range of average speeds shown for vehicular travel is between 25 mph and 90 mph. For the embodiment shown, the range of average speeds for running (5-12 mph) and biking (9-30 mph) overlap between 9 mph and 12 mph. An average speed of 8 mph indicates a user of the device 102 is running. An average speed of 10 mph, however, is indeterminate based on the average velocity alone. At this speed, the device 102 uses additional information in the motion profile 402 to determine a transportation mode.

For a particular embodiment, the device 102 uses position data in addition to speed data to determine a transportation mode. Positions indicated by the device's GPS receiver, for example, when taken collectively, define a route for the device 102. In a first instance, the route coincides with a rail line, and the device 102 determines the transportation mode to be a train. In a second instance, the route coincides with a waterway, and the device 102 determines the transportation mode to be a boat. In a third instance, the route coincides with an altitude above ground level, and the device 102 determines the transportation mode to be a plane.

For an additional embodiment, determining a motion profile for the device 102 includes determining a transportation mode for the device 102, and the transportation mode is determined based on a type of application being run on the device 102. Certain applications run on device 102, for example, might concern exercise, such as programs that monitor cadence, heart rates, and speed while providing a stopwatch function, for example. When an application specifically designed for jogging is running on the device 102, it serves as a further indication that a user of the device 102 is in fact jogging. In another embodiment, the time-dependent residual velocity is used to determine the transportation mode for otherwise indeterminate cases and also to ensure reliability when average speeds do indicate particular transportation modes.

FIG. 6 shows a diagram 600 of a user jogging with the device 102 in accordance with some embodiments of the present teachings. The diagram 600 also shows time-dependent velocity components for the jogger (and thus for the device 102 being carried by the jogger) at four points 620-626 in time. At a time corresponding to the jogger's first position 620, the device 102 has an instantaneous (as measured at that point in time) horizontal velocity component v₁ₕ 602 and a vertical component v₁ᵥ 604. For the jogger's second 622, third 624, and fourth 626 positions, the horizontal velocity components are v₂ₕ 606, v₃ₕ 610, and v₄ₕ 614, while the vertical velocity components are v₂ᵥ 608, v₃ᵥ 612, and v₄ᵥ 616, respectively. The jogger's average velocity is indicated at 618.

Focusing on the vertical velocity components, at the first position 620, the jogger begins to push off his right foot and acquires an upward velocity of v₁ᵥ 604. As the jogger continues to push off his right foot in the second position 622, his vertical velocity grows to v₂ᵥ 608, as indicated by the longer vector. In the third position 624, the jogger has passed the apex of his trajectory. As his left foot hits the ground, the jogger has a downward velocity of v₃ᵥ 612, and in the fourth position 626, the downward velocity is arrested somewhat to measure v₄ᵥ 616. This pattern of alternately moving up and down in the vertical direction while the average velocity 618 is directed forward is indicative of a person jogging. When the jogger holds the device 102 in his hand, the device 102 measures time-dependent velocity components that also reflect the jogger pumping his arms back and forth. This velocity pattern is unique to jogging. If the jogger were instead biking with the same average speed, the vertically oscillating time-dependent velocity pattern would be exchanged for another. The time-dependent velocity components thus represent a type of motion “fingerprint” that serves to identify a particular transportation mode.

For an embodiment, the device 102 determining the motion profile 402 includes it determining time-dependent velocity components, that differ from the time-averaged velocity, and using the time-dependent velocity components to determine the transportation mode. When an average velocity indication of 10 mph is insufficient for the device 102 to definitively determine a transportation mode because it falls with the range of average speeds for both running and biking, for example, the device 102 considers additional information. For an embodiment, this additional information includes the time-dependent velocity components. In a further embodiment, the device 102 distinguishes between an automobile, a boat, a train, and a motorcycle as a transportation mode based on analyzing time-dependent velocity components.

FIG. 7 shows a diagram 700 of a user running with the device 102 in accordance with some embodiments of the present teachings. Specifically, FIG. 7 shows four snapshots 726-732 of the runner taken over an interval of time in which the runner makes two strides. The runner is shown taking longer strides, as compared to the jogger in diagram 600, and landing on his heels rather than the balls of his feet. Measured velocity components in the horizontal (v₁ₕ 702, v₂ₕ 706, v₃ₕ 710, v₄ₕ 714) and vertical (v₁ᵥ 704, v₂ᵥ 708, v₃ᵥ 712, and v₄ᵥ 716) directions allow the device 102 to determine that its user is running, and the average velocity, shown at 718, indicates how fast the he is running. The device 102 having the ability to distinguish between running and jogging is important because running is associated with a higher level of stress that can more dramatically affect the speech signal in the acoustic signal.

For some embodiments, the device 102 determining the noise profile 406 includes the device 102 detecting at least one of user stress or noise level, and wherein modifying the speech signal includes modifying at least one of rate of speech, pitch, or frequency of the speech signal based on at least one of the user stress or the noise level. From collected data compiled in the motion profile 402, the device 102 is aware that the user is running and of the speed at which he is running. This activity translates to a quantifiable level of stress that has a given affect upon the user's speech and can also result in increased levels of noise. For example, the speech may be accompanied by heavy breathing, be varying in rate (such as quick utterances between breaths), be frequency shifted up, and/or be unevenly pitched.

In a particular embodiment, the device 102 modifying the speech signal further includes phoneme correction based on adaptive training of the device 102 to the user stress or the noise level. For this embodiment, programming within the voice recognition module 206 gives the device 102 the ability to learn a user's speech and the associated level of noise during periods of stress or physical exertion. While the speech-recognition software is running in a training mode, the user runs, or exerts himself as he otherwise would, while speaking prearranged phrases and passages into a microphone of the device 102. In this way, the voice recognition module 206 tunes itself to how the user's phonemes and utterances change while exercising. When the user is again engaged in the stressful activity, as indicated by the motion environment profile 408, the voice recognition module 206 switches to the correct database or file that allows the device 102 to interpret the stressed speech for which it was previously trained. This method provides improved voice-recognition accuracy during times of exercise or physical exertion.

In an embodiment where determining a motion profile 402 includes determining a transportation mode, the device 102 adapting voice recognition processing includes the device 102 removing at least a portion of percussive noise, resulting from the transportation mode, from the acoustic signal. The percussive noise results from footfalls when the transportation mode includes traveling by foot or the percussive noise results from road irregularities when the transportation mode includes traveling by motor vehicle. The first type of percussive event is shown at 720. As the runner's left heel strikes the ground, there is a jarring that causes a shock and imparts rapid acceleration to the membrane of the microphone used to capture speech. The percussive event can also momentarily affect the speech itself as air is pushed from the lungs. The second percussive event is shown at 722 as the runner's right heel strikes the ground. When the runner is running at a constant rate, the heel strikes are periodic and occur at regular intervals. The percussive interval for the runner is shown at 724. When the percussive events are uniformly periodic, the device 102 can anticipate the times they will occur and use compression, suppression, or removal when performing noise reduction.

A second type of percussive event occurs randomly and cannot be anticipated. This occurs, for example, as potholes are encountered while the transportation mode is vehicular travel. The time at which this type of percussive event occurs is identified by the impulse imparted to one or more accelerometers of the device 102. The device 102 can then use compression, suppression, or removal when performing noise reduction on the acoustic signal by applying the noise reduction at the time index indicated by the one or more accelerometers.

For an embodiment where the motion profile 402 includes determining a time-averaged velocity for the device 102 based on a set of time-dependent velocity components for the device 102, the device 102 modifying the speech signal includes the device 102 modifying at least one of an amplitude or frequency of the speech signal based on at least one of the time-averaged velocity or the time-dependent velocity components. The device 102 applies this type of signal modification when it experiences periodic motion relative to a user's mouth.

Shown at 800, in FIGS. 8A and 8B, is a user running with the device 102. That the user is running is determined from the average speed and time-dependent velocity components for the device 102, and indicated in the motion environment profile 408. At 810, the runner has the device 102 strapped to her right upper arm, whereas at 812, she is holding the device 102 in her left hand. As her hand and arm pump forward and back while she is running, the position and velocity of the device 102 relative to her mouth change as she is speaking. This relative motion affects the amplitude and frequency of the speech. As shown at 810, the distance 802 is at its greatest when the runner's right arm is fully behind her. In this position, her mouth is farthest away from the device 102 so that the amplitude of captured speech will be at a minimum. While she moves her right arm forward, the velocity 804 of the device 102 is toward her mouth, and the frequency of her speech will be Doppler shifted up as the distance closes.

At 812, the device 102 is at a distance 806 that is relatively close to the runner's mouth, so the amplitude of her speech received at the microphone will be higher. The velocity 808 of the device 102 is directed away from her mouth so as her speech is received, it will be Doppler shifted down. Having knowledge of the velocity or acceleration of the device 102 allows for modification of the acoustic signal to account for the repetitive motion of the device 102. Motion-based speech effects, such as modulation effects, can be overcome by adapting the gain of the signal based on the time-dependent velocity vectors captured by the motion sensors 204. Additionally, the Doppler shifting caused by periodic or repetitive motion can be overcome as well.

For a particular embodiment, the device 102 improves the speech signal by modifying it in several ways. The device 102 modifies the frequency of the speech signal to adjust for Doppler shift, modifies the amplitude of the speech signal to adjust for a changing distance between the device's microphone and a user's mouth, modifies the rate of speech in the speech signal to adjust for a stressed user speaking quickly, and/or modifies the pitch of the speech signal to adjust for a stressed user speaking at higher pitch. In a further embodiment, the device 102 makes continuous, time-dependent modifications to correct for varying amounts of frequency shift, amplitude change, rate increase, and pitch drift in the speech signal. These modifications increase the accuracy of voice recognition over a variety of activities in which the user might engage.

FIG. 9 shows a schematic diagram 900 illustrating the determination of a temperature profile for the device 102 in accordance with some embodiments of the present teachings. Indicated on the diagram at 902, is a temperature measured at the device 102 of 71 degrees. In an embodiment, this temperature is taken using the thermocouple 106. Indicated at 904, is a reported temperature (also referred to herein as a location-based temperature reading) from a second device external to the device 102 of 87 degrees. The reported temperature can be a forecasted temperature or a temperature taken at a weather station for an area in which the device 102 is located, based on its location information. The location-based temperature reading therefore represents an outdoor temperature at the location of the device 102. A threshold band centered at the reported temperature appears at 906.

For a particular embodiment, the device 102 determining a temperature profile includes the device 102: determining a first temperature reading using a temperature sensor internal to the device 102; determining a temperature difference between the first and second temperature readings; and determining a temperature indication of whether the device 102 is indoors or outdoors based on the temperature difference, wherein the motion environment profile 408 is determined based on the temperature indication. In the embodiment shown at 900, the temperature indication is set to indoors because the difference between the reported (second) temperate and the device-measured (first) temperature is greater than a threshold value of half the threshold band 906. In an embodiment where the first temperature is measured to be 85 degrees, the temperature indication is set to outdoors because the first temperature falls within the threshold band 906. In this case, the two-degree discrepancy between the first and second temperature readings is attributed to measurement inaccuracies and temperature variances over the area in which the device 102 is located.

In an embodiment for which the location-based temperature is 71 degrees, the method depicted at 900 for determining a temperature indication is indeterminate. If the outside temperature is the same as the indoor temperature, a temperature reading at the device 102 provides no useful information in determining if the device 102 is indoors or outdoors. For a particular embodiment, the width of the threshold band is a function of the reported temperature. When the outdoor temperature (e.g., 23° F.) is very different from a range of common indoor temperatures (e.g., 65-75° F.), less accuracy is needed, and the threshold band 906 may be wider. As the reported outdoor temperature becomes closer to a range of indoor temperatures, the threshold band becomes more narrow.

Using a method analogous to that depicted at 900, a noise indication is set to indicate if the device 102 is indoors or outdoors. FIG. 10 shows a diagram 1000 illustrating a method for determining the noise indication based on a wind profile and a measured speed for the device 102. Shown in the diagram 1000 is a wind profile indicating a wind speed of 3 mph, at 1004. At 1002, a GPS receiver for the device 102 indicates the device 102 is moving with a speed of 47 mph. A threshold band, centered at the GPS speed 1002, is shown at 1006.

In an embodiment where determining the motion profile 402 includes determining the device 102 speed, the device 102 determining the noise profile 406 includes the device 102: detecting wind noise; analyzing the wind noise to determine a wind speed; and setting a noise indication based on a calculated difference between the wind speed and the device speed. In the embodiment shown at 1000, the device 102 takes an ambient noise sample (from the acoustic signal using the VAD 208, for example) and compares a wind-noise profile taken from it to stored spectra and amplitude levels for known wind speeds. Analyzing the sample in this way, the device 102 determines that the wind profile matches that of a 3 mph wind. The GPS receiver, however, indicates the device 102 is traveling at 47 mph. Based on the large difference between the wind speed and the device speed, the device 102 determines that it is in an indoor environment (e.g., traveling in an automobile with the windows rolled up) and sets the noise indication to indicate an indoor environment.

For the embodiment shown, any wind speed that falls outside the threshold band 1006 is taken to indicate the device 102 is in an indoor environment, and the noise indication is set to reflect this. In an embodiment where the wind speed is determined to be 46 mph from comparisons with stored wind speed profiles, the device 102 sets the noise indication to indicate an outdoor environment because the wind speed falls within the threshold band 1006 centered at 47 mph. For a particular embodiment, the width of threshold band 1006 is a function of the speed indicated for the device 102 by the GPS receiver or other speed-measuring sensor.

For one embodiment, the device 102 sets the noise indication to indicate that the device 102 is indoors or outdoors based on an absolute value of the difference between the wind speed and the device speed. Particularly, when the absolute value of the difference between the wind speed and the device speed is greater than a threshold speed, the device 102 selects, based on the indoors noise indication, multiple microphones to receive the acoustic signal. Whereas, when the absolute value of the difference between the wind speed and the device speed is less than the threshold speed, the device 102 selects, based on the outdoors noise indication, a single microphone to receive the acoustic signal. For this embodiment, the threshold speed is represented in the diagram 1000 by half the width of the threshold band 1006. The embodiment also serves as an example of when adapting the voice recognition module 206 includes changing a microphone, or changing a number of microphones, used to receive the acoustic signal. Multiple-microphone algorithms offer better performance indoors, whereas single-microphone algorithms are a better choice for outdoor use when wind is present because a single-microphone is better able to mitigate wind noise.

FIG. 11 is a logical flowchart of a method 1100 for determining the stationarity of noise to perform noise reduction in accordance with some embodiments of the present teachings. As used herein, the stationarity of noise is an indication of its time independence. The spectrum for stationary noise remains relatively constant in time (as compared to the spectrum for non-stationary noise). Tire noise from an automobile driving on smooth and uniformly paved roadway is an example of stationary noise. Conversely, the ambient noise at a crowded venue, such as a sporting event, is an example of non-stationary noise. The noise spectrum at a football game, for instance, is continuously changing due to random sounds and background chatter. Wind noise is another example of a non-stationary noise.

For the method 1100, the device 102 receives 1102 an acoustic signal, analyzes 1104 the noise in the signal, and makes 1106 a determination of whether the noise is stationary or non-stationary. When the noise is determined to be non-stationary, the device 102 increases 1108 the trigger threshold for voice recognition. The term “trigger,” as used herein, refers to an event or condition that causes or precipitates another event, whereas the term “trigger threshold” refers to a sensitivity of the trigger to that event or condition. In an embodiment relating to command recognition, the trigger condition is a match between phonemes received in voice data to phonemes stored as reference data. When a match occurs, the device 102 performs the command represented by the phonemes. What constitutes a match is determined by the trigger threshold. For the same embodiment, the trigger sensitivity is the minimum degree to which the phonemes must match before the command is performed. For example, in a noisy environment where the noise is non-stationary, the trigger threshold is set high (i.e., increased), requiring a 95% phoneme match, to prevent false positives. Such false positives can be caused by other voices or random sound occurrences in the noise.

When the device 102 determines that the noise is stationary, it lowers 1110 the trigger threshold for voice recognition, making the trigger less discriminating (using lower tolerances to “open up” the trigger so that it is more easily “tripped”). This is because a false positive is not likely to be received from stationary noise that does not change with time. For a particular embodiment, the device 102 determining a noise profile for the acoustic signal includes the device 102 determining whether noise in the acoustic signal is stationary or non-stationary, and the device 102 adapting voice recognition processing includes the device 102 adjusting a trigger threshold to make a trigger for voice recognition less discriminating when the noise is determined to be stationary relative to when the noise is determined to be non-stationary.

In another embodiment, the device 102 determining a noise profile for the acoustic signal includes the device 102 determining whether noise in the acoustic signal is stationary or non-stationary, and the device 102 further performs noise reduction on the acoustic signal, wherein the noise reduction includes road noise reduction when the noise is determined to be stationary and wind noise reduction when the noise is determined to be non-stationary. To overcome difficulties associated with differentiating between road noise and wind noise, the device 102 applies a road noise model or a wind noise model depending on whether the noise is determined 1106 to be stationary or non-stationary, respectively. When the noise is determined 1106 to be stationary, the device 102 uses 1114 a road noise model for noise reduction and performs 1116 noise reduction for the acoustic signal. When the noise is determined 1106 to be non-stationary, the device 102 uses 1112 a wind noise model for noise reduction and performs 1116 noise reduction for the acoustic signal.

When the device 102 determines 1106 noise in the acoustic signal is non-stationary, each of the actions 1108 and 1112 can be performed optionally in place of or in addition to the other. Similarly, when the device 102 determines 1106 noise in the acoustic signal is stationary, each of the actions 1110 and 1114 can be performed optionally in place of or in addition to the other. Therefore, each of the four actions 1108-1114 is shown in FIG. 11 as an optional action.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by a device for adapting voice recognition processing, the method comprising:
receiving into the device an acoustic signal comprising a speech signal, which is provided to a voice recognition module;
determining a motion profile for the device;
determining a temperature profile for the device;
determining a noise profile for the acoustic signal;
determining, from the motion, temperature, and noise profiles, a motion environment profile for the device; and
adapting voice recognition processing for the speech signal based on the motion environment profile.

2. The method of claim 1, wherein adapting voice recognition processing for the speech signal comprises modifying the speech signal before providing the speech signal to a voice recognition engine within the voice recognition module.

3. The method of claim 2, wherein determining the motion profile comprises determining a time-averaged velocity for the device based on a set of time-dependent velocity components for the device, and wherein modifying the speech signal comprises modifying at least one of an amplitude or frequency of the speech signal based on at least one of the time-averaged velocity or the time-dependent velocity components.

4. The method of claim 2, wherein determining the noise profile comprises determining at least one of noise level or noise type, and wherein modifying the speech signal comprises modifying at least one phoneme within the speech signal based on at least one of the noise level or the noise type.

5. The method of 2, wherein determining the noise profile comprises detecting at least one of user stress or noise level, and wherein modifying the speech signal comprises modifying at least one of rate of speech, pitch, or frequency of the speech signal based on at least one of the user stress or the noise level.

6. The method of claim 5, wherein modifying the speech signal further comprises phoneme correction based on adaptive training of the device to the user stress or the noise level.

7. The method of claim 1, wherein adapting voice recognition processing for the speech signal comprises adapting the voice recognition module, which comprises at least one of:
selecting a voice recognition database based on the motion environment profile; or
selecting a voice recognition engine based on the motion environment profile.

8. The method of claim 1, wherein determining the temperature profile comprises:
determining a first temperature reading using a temperature sensor internal to the device;
receiving a second location-based temperature reading from a second device external to the device;
determining a temperature difference between the first and second temperature readings; and
determining a temperature indication of whether the device is indoors or outdoors based on the temperature difference, wherein the motion environment profile is determined based on the temperature indication.

9. The method of claim 1, wherein determining the motion profile comprises determining a time-averaged velocity for the device and determining a transportation mode based on the time-averaged velocity.

10. The method of claim 9, wherein determining the motion profile further comprises determining time-dependent velocity components for the device that differ from the time-averaged velocity, and wherein determining the transportation mode is further based on the time-dependent velocity components.

11. The method of claim 1, wherein:
determining the motion profile comprises determining a device speed;
determining the noise profile comprises:
detecting wind noise;
analyzing the wind noise to determine a wind speed; and
setting a noise indication based on a calculated difference between the wind speed and the device speed.

12. The method of claim 11, wherein the noise indication is set to indicate that the device is indoors or outdoors based on an absolute value of the difference between the wind speed and the device speed, wherein:
when the absolute value of the difference between the wind speed and the device speed is greater than a threshold speed, the method further comprising selecting, based on the indoors noise indication, multiple microphones to receive the acoustic signal; and when the absolute value of the difference between the wind speed and the device speed is less than the threshold speed, the method further comprising selecting, based on the outdoors noise indication, a single microphone to receive the acoustic signal.

13. The method of claim 1, wherein determining a noise profile for the acoustic signal comprises determining that noise in the acoustic signal is stationary or non-stationary, and wherein adapting voice recognition processing comprising adjusting a trigger threshold to make a trigger for voice recognition less discriminating when the noise is determined to be stationary relative to when the noise is determined to be non-stationary.

14. The method of claim 1, wherein determining a noise profile for the acoustic signal comprises determining that noise in the acoustic signal is stationary or non-stationary, and the method further comprising performing noise reduction on the acoustic signal, wherein the noise reduction comprises road noise reduction when the noise is determined to be stationary and wind noise reduction when the noise is determined to be non-stationary.

15. The method of claim 1, wherein determining a motion profile for the device comprises determining a transportation mode for the device, and wherein the transportation mode is determined based on a type of application being run on the device.

16. The method of claim 1, wherein determining a motion profile comprises determining a transportation mode, and wherein adapting voice recognition processing comprises removing at least a portion of percussive noise, resulting from the transportation mode, from the acoustic signal, wherein the percussive noise results from footfalls when the transportation mode comprises traveling by foot or the percussive noise results from road irregularities when the transportation mode comprises traveling by motor vehicle.

17. A device configured to perform voice recognition, the device comprising:
at least one acoustic transducer configured to receive an acoustic signal comprising a speech signal;
a voice-recognition module configured to perform voice recognition on the speech signal;
a set of motion sensors configured to collect motion data;
a temperature sensor configured to measure a first temperature at the device;
an interface configured to receive a second temperature for the location of the device; and
a processing element configured to determine, from the acoustic signal, the motion data, and the first and second temperatures, a motion environment profile for the device and to adapt voice recognition processing for the speech signal based on the motion environment profile.

18. The device of claim 17, wherein the set of motion sensors comprises at least one of:
an accelerometer;
a velocity sensor;
an air flow sensor;
a global positioning system receiver; or
network triangulation hardware.

19. The device of claim 17 further comprising a signal processing module configured to adapt voice recognition processing by modifying at least one of a frequency of speech, an amplitude of speech, or a rate of speech for the speech signal.

20. The device of claim 17 further comprising a first and a second voice recognition engine, wherein adapting voice recognition processing comprises selecting the second voice recognition engine, based on the motion environment profile, to replace the first voice recognition engine as an active voice recognition engine.
